(19) United States
(12) Patent Application Publication
(10) Pub. No.: US 2010/0169540 A1
(43) Pub. Date: Jul. 1, 2010

(54) METHOD AND APPARATUS FOR RELOCATING SELECTED DATA BETWEEN FLASH PARTITIONS IN A MEMORY DEVICE

(76) Inventor: Alan W. Sinclair, Falkirk (GB)

Correspondence Address: BRINKS HOFER GILSON & LIONE/SanDisk, P.O. BOX 10395, CHICAGO, IL, 60610, US

(21) Appl. No.: 12/345,990

(22) Filed: Dec. 30, 2008

(51) Int. Cl. G06F 12/02

(52) U.S. Cl. 711/103; 711/E12.008

(57) ABSTRACT

A method and system for relocating selected groups of data in a storage device having a non-volatile memory consisting partitions with different types of non-volatile memory. The method may include determining whether data received a first partition meets one or more heightened read probability criteria and/or heightened delete probability criteria. If the criteria are not met, the received data is moved to a second partition, where the first partition has a higher endurance than the second partition. The system may include a first non-volatile memory partition and a second non-volatile memory partition having a lower endurance than the first, where a controller in communication with the first and second partitions determines if a heightened read probability and/or a heightened delete probability are present in received data.

### TECHNICAL FIELD

This disclosure relates generally to storage of data on storage devices and, more particularly, to storage of data in different regions of a storage device.

### BACKGROUND

Non-volatile memory systems, such as flash memory, have been widely adopted for use in consumer products. Flash memory may be found in different forms, for example in the form of a portable memory card that can be carried between host devices or as a solid state drive (SSD) embedded in a host device. Two general memory cell architectures found in flash memory include NOR and NAND. In a typical NOR architecture, memory cells are connected between adjacent bit line source and drain diffusions that extend in a column direction with control gates connected to word lines extending along rows of cells. A memory cell includes at least one storage element positioned over at least a portion of the cell channel region between the source and drain. A programmed level of charge on the storage elements thus controls an operating characteristic of the cells, which can then be read by applying appropriate voltages to the addressed memory cells.

A typical NAND architecture utilizes strings of more than two series-connected memory cells, such as 16 or 32, connected along with one or more select transistors between individual bit lines and a reference potential to form columns of cells. Word lines extend across cells within many of these columns. An individual cell within a column is read and verified during programming by causing the remaining cells in the string to be turned on so that the current flowing through a string is dependent upon the level of charge stored in the addressed cell.

NAND flash memory can be fabricated in the form of single-level cell flash memory, also known as SLC or binary flash, where each cell stores one bit of binary information. NAND flash memory can also be fabricated to store multiple states per cell so that two or more bits of binary information may be stored. This higher storage density flash memory is known as multi-level cell or MLC flash. MLC flash memory can provide higher density storage and reduce the costs associated with the memory. The higher density storage potential of MLC flash tends to have the drawback of less durability than SLC flash in terms of the number write/erase cycles a cell can handle before it wears out. MLC can also have slower read and write rates than the more expensive and typically more durable SLC flash memory. Memory devices, such as SSDs, may include both types of memory.

It is desirable to provide for systems and methods to address the strengths and weaknesses noted above of these different types of non-volatile memory.

### SUMMARY

In order to address the problems noted above, a method and system for relocating selected data between flash partitions of a memory device is disclosed, where predictions of likelihood of read activity and or deletion of received groups of data are used to determine which type of memory in a storage device is most appropriate for storing each particular group of data.

According to a first aspect of the invention, a method of relocating selected data between partitions in a non-volatile storage device is disclosed. The method includes receiving data in a first type of non-volatile memory in the non-volatile storage device. A determination is made in the non-volatile storage device as to whether the received data satisfies heightened read probability criteria, where the heightened read probability criteria identify received data having a greater probability of being read from the non-volatile storage device in a near term than an average read probability of data in the non-volatile storage device. If the received data is determined not to satisfy the criteria, the data is transferred from the first type of non-volatile memory to a second type of non-volatile memory in the non-volatile storage device, where the first type of non-volatile memory comprises a higher endurance memory than the second type of non-volatile memory.

According to another aspect of the invention, a method of relocating selected data between partitions in a non-volatile storage device may include receiving data in a first type of non-volatile memory in the non-volatile storage device. The method may further include determining in the non-volatile storage device if the received data satisfies a deletion probability criteria, where the deletion probability criteria identifies received data having a heightened probability of being deleted. The received data is transferred from the first type of non-volatile memory to a second type of non-volatile memory in the non-volatile storage device only if the received data fails to meet the deletion probability criteria, where the first type of non-volatile memory comprises a higher endurance memory than the second type of non-volatile memory. In an alternative embodiment, the non-volatile storage device may determine if the received data satisfies criteria for either a heightened read probability or a heightened probability of deletion and will transfer the received data from the first to the second type of non-volatile memory if either or both sets of criteria are satisfied.

Other features and advantages will become apparent upon review of the following drawings, detailed description and claims.

### BRIEF DESCRIPTION OF THE DRAWINGS

FIG. 1 is a block diagram of a memory system having a storage device with two partitions, each partition having a different type of non-volatile storage.

FIG. 2 illustrates an example physical memory organization of the system of FIG. 1.

FIG. 3 shows an expanded view of a portion of the physical memory of FIG. 2.

FIG. 4 is a flow diagram illustrating a method of improving write and/or read performance in the storage device of FIG. 1.

FIG. 5 is a data structure for correlating a data ID of an LBA range to other data IDs of other data ranges that together form read groups.

FIG. 6 is a data structure of a most recently read list of data IDs for LBA ranges.

FIG. 7 is a state diagram of the allocation of blocks of clusters using storage address re-mapping in a non-volatile memory having binary and MLC partitions.

FIG. 8 is a write block for a block information table (BIT) that may be used to record and track information on blocks in the storage device of FIG. 1

### BRIEF DESCRIPTION OF THE PRESENTLY PREFERRED EMBODIMENTS

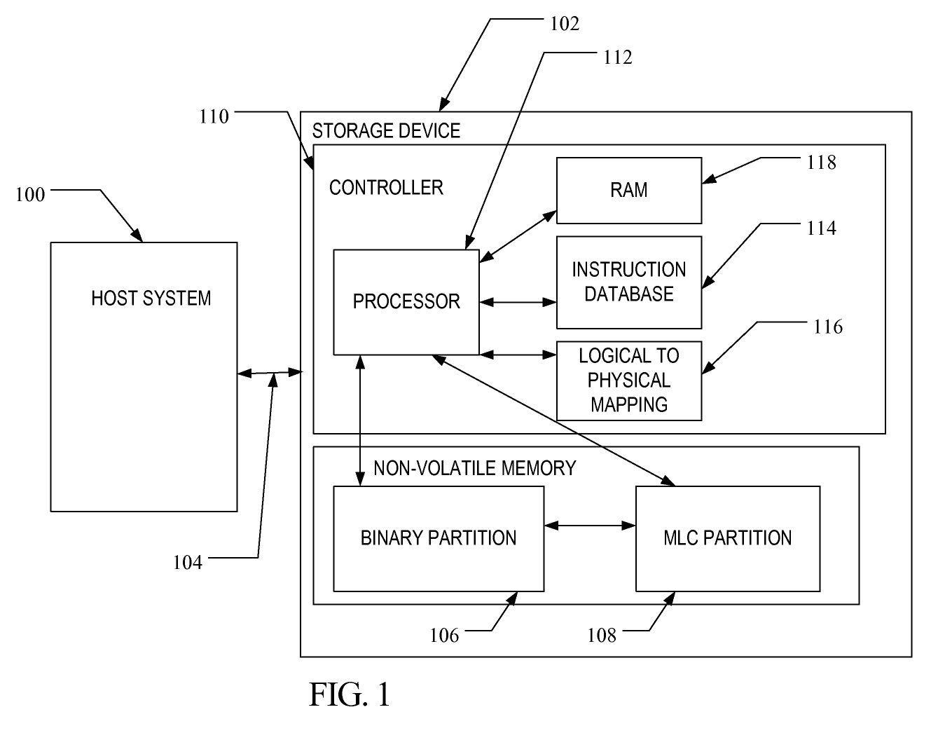

A flash memory system suitable for use in implementing aspects of the invention is shown in FIG. 1. A host system 100 stores data into, and retrieves data from, a storage device 102. The storage device 102 may be a solid state drive (SSD) embedded in the host 100 or may exist in the form of a card or other removable drive that is removably connected to the host 100 through a mechanical and electrical connector. The host 100 may be any of a number of data generating devices, such as a personal computer. The host 100 communicates with the storage device over a communication channel 104. The storage device 102 includes a controller 110 that may include a processor 112, instructions 114 for operating the processor 112, and a logical block to physical block translation table 116.

The storage device 102 contains non-volatile memory cells in separate partitions, each partition containing a different type of non-volatile memory cell. For example, the storage device 102 may have a binary partition 106 and a multi-level cell (MLC) partition 108. Each partition having a different performance level, such as read and write speed and endurance. As used herein, the term “endurance” refers to how many times a memory cell (i.e., a non-volatile solid state element) in a memory array can be reliably programmed. Typically, the more bits per memory cell that a particular type of non-volatile memory can handle, the fewer programming cycles it will sustain. Thus, the binary partition 106, which is fabricated of single level cell (SLC) flash memory cells having a one bit per cell capacity (two storage states per cell), would be considered the higher endurance memory partition while the multi-level cell (MLC) flash memory cells having more than a one bit per cell capacity would be considered the lower endurance partition.

The MLC flash memory cells may be able to store more information per cell, but they tend to have a lower durability and wear out in fewer programming cycles than SLC flash memory. While binary (SLC) and MLC flash memory cells are provided as one example of higher endurance and lower endurance storage partitions, respectively, other types of non-volatile memory having relative differences in endurance may be used. Different combinations of flash memory types are also contemplated for the higher endurance and lower endurance storage portions 106, 108. For example, more than two types of MLC (e.g., 3 bits per cell and 4 bits per cell) may be used with SLC flash memory cells, such that there are multiple levels of endurance, or two or more different types of MLC flash memory cells may be used without using SLC cells. In the latter example, the MLC with the lower number of bits per cell would be considered the high endurance storage and the MLC with the higher bits per cell would be considered the low endurance storage. As described in greater detail below, the processor 112 in the controller 110 may track and store information on the times of each write and/or read operation performed on groups of data and the relationship of groups of data. This log of read or write activity may be stored locally in random access memory (RAM) 118 available on the storage device 102 generally, RAM within the processor 112 (not shown), in the binary partition 106 or some combination of these locations.

The binary partition 106 and MLC partition 108, as mentioned above, may be non-volatile flash memory arranged in blocks of memory cells. A block of memory cells is the unit of erase, i.e., the smallest number of memory cells that are physically erasable together. For increased parallelism, however, the blocks may be operated in larger metablock units. One block from each plane of memory cells may be logically linked together to form a metablock. In the storage device 102 of FIG. 1, a metablock arrangement is useful because multiple cache blocks may be needed to store an amount of data equal to one main storage block.

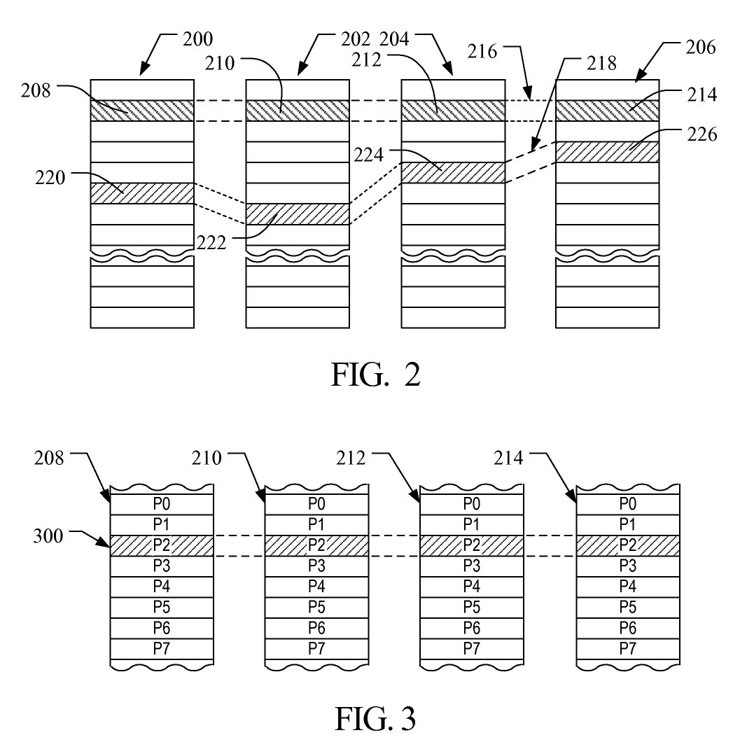

Referring to FIG. 2, a conceptual illustration of a representative flash memory cell array is shown. Four planes or sub-arrays 200, 202, 204 and 206 memory cells may be on a single integrated memory cell chip, on two chips (two of the planes on each chip) or on four separate chips. The specific arrangement is not important to the discussion below and other numbers of planes may exist in a system. The planes are individually divided into blocks of memory cells shown in FIG. 2 by rectangles, such as blocks 208, 210, 212 and 214, located in respective planes 200, 202, 204 and 206. There may be dozens or hundreds of blocks in each plane. Blocks may be logically linked together to form a metablock that may be erased as a single unit. For example, blocks 208, 210, 212 and 214 may form a first metablock 216. The blocks used to form a metablock need not be restricted to the same relative locations within their respective planes, as is shown in the second metablock 218 made up of blocks 220, 222, 224 and 226.

The individual blocks are in turn divided for operational purposes into pages of memory cells, as illustrated in FIG. 3. The memory cells of each of blocks 208, 210, 212 and 214, for example, are each divided into eight pages P0-P7. Alternately, there may be 16, 32 or more pages of memory cells within each block. A page is the unit of data programming (writing) and reading within a block, containing the minimum amount of data that are programmed (written) or read at one time. A metapage 300 is illustrated in FIG. 3 as formed of one physical page for each of the four blocks 208, 210, 212 and 214. The metapage 300 includes the page P2 in each of the four blocks but the pages of a metapage need not necessarily have the same relative position within each of the blocks. A metapage is the maximum unit of programming. The blocks disclosed in FIGS. 2-3 are referred to herein as physical blocks because they relate to groups of physical memory cells as discussed above. As used herein, a logical block is a virtual unit of address space defined to have the same size as a physical block. Each logical block includes a range of logical block addresses (LBAs) that are associated with data received from a host 100. The LBAs are then mapped to one or more physical blocks in the storage device 102 where the data is physically stored.

In some embodiments, a data management scheme, such as storage address remapping, operates to take LBAs associated with data sent by the host and remaps them to a second logical address space or directly to physical address space in an order the data is received from the host. Alternatively, as discussed in more detail below, multiple write blocks may be open simultaneously where the storage address re-mapping may be configured within the storage device 102 to remap received data having a particular characteristic into a specific one of the write blocks reserved for data with that particular characteristic, but in an order that data is received from the host. Each LBA corresponds to a sector, which is the minimum unit of logical address space addressable by a host. A host will typically assign data in clusters that are made up of one or more sectors. Also, in the following discussion, the term block is a flexible representation of storage space and may indicate an individual erase block or, as noted above, a logically interconnected set of erase blocks defined as a metablock. If the term block is used to indicate a metablock, then a corresponding logical block of LBAs should consist of a block of addresses of sufficient size to address the complete physical metablock.

Data to be written from the host system 100 to the memory system 102 may be addressed by clusters of one or more sectors managed in blocks. A write operation may be handled by writing data into a write block, and completely filling that block with data in the order data is received. This allows data to be written in completed blocks by creating blocks with only unwritten capacity by means of flushing operations on partially obsolete blocks containing obsolete and valid data. A flushing operation may include relocating valid data from a partially obsolete block to another block, for example, to free up the flushed block for use in a pool of available blocks. Additional details on one storage address re-mapping technique may be found in U.S. application Ser. No. 12/036,014, filed Feb. 22, 2008 and entitled “METHOD AND SYSTEM FOR STORAGE ADDRESS RE-MAPPING FOR A MEMORY DEVICE”, the entirety of which is incorporated herein by reference.

In operation, the storage device 102 will receive data from the host 100 associated with host write commands. The data received at the storage device 102 is addressed in logical blocks of addresses by the host 100 and, when the data is stored in the storage device 102, the processor 112 tracks the mapping of logical addresses to physical addresses in a logical to physical mapping table 116. In one embodiment, the processor 112 may first utilize a data management scheme such as the storage address re-mapping technique noted above to re-map the received data into blocks of data related by LBA range, file type, file size or some other criteria, before then writing the data into physical addresses. When the storage device 102, such as the example shown in FIG. 1, includes more than one type of storage, such as the binary and MLC partitions 106, 108, optimizing the location of groups of data in these different areas to account for the cost, speed or endurance of the type of memory can permit greater overall performance and life-span for the storage device. As used herein, a “group” of data may refer to a sector, page, block, file or any other data object.

In order to optimize the use of the different partitions 106, 108 in the storage device 102, the storage device 102 may be configured to improve write performance by maximizing the ability of a host to write data to the binary partition 106, to improve read performance by increasing the probability that data to be read will be available in the binary partition, and/or to improve the life of the storage device by minimizing the amount of data that is deleted or made obsolete in the MLC partition.

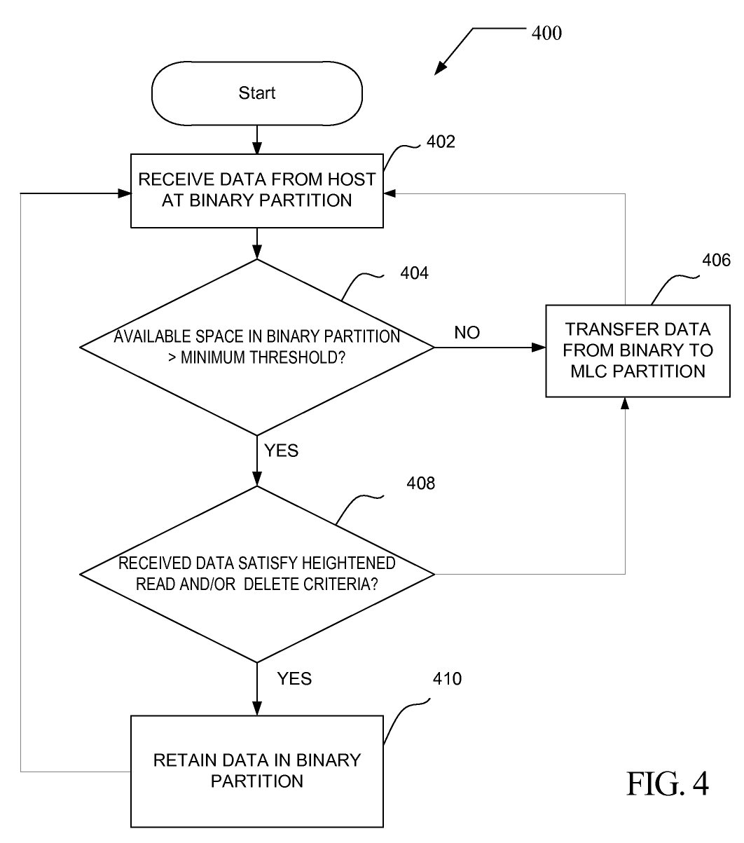

In one embodiment, the write performance, read performance and life of the storage device may be improved by the process illustrated in FIG. 4. The process may be carried out via software or firmware instructions executed by the controller in the storage device or with hardware configured to execute the instructions. As shown in FIG. 4 when data is received from the host 100 it is first directed to the binary partition 106 of the storage device 102 (at 402). If at least a minimum amount of available space remains in the binary partition 106, the processor 112 determines (at 404, 406) if the data has a heightened probability of being read or a heightened probability of being deleted. Although any of a number of data storage ratios are contemplated, one example of a minimum threshold for available space in the binary partition may be 10% of the capacity of the binary partition, where the binary partition has a capacity of 10% of the MLC partition capacity and the MLC partition has a 256 Gigabyte capacity. The parameter for minimum space availability may be stored in non-volatile memory of the storage device or in non-volatile memory within the processor 112. This minimum amount of available space may be a predetermined amount of space, or may be configurable by a user. Ideally, the minimum available binary space is selected to allow the storage device to meet or exceed burst write and sustained write speed specifications for the storage device.

Assuming at least the minimum free space is available in the binary partition, the storage device 102 determines if the received data is to be retained in the binary partition 106 or moved to the MLC partition 108. In order to accomplish this, the controller 110 of the storage device 102 makes a determination of whether the received data satisfies criteria for one or both of having a heightened probability of being read in the near operating future of the storage device or a heightened probability of being deleted or made obsolete in the near operating future of the storage device. If the received data to satisfies one or both of the read probability or delete probability criteria, it is retained in the binary partition (at 408, 410). This will allow for the storage device to provide the faster read response available from the binary partition and may prevent premature wear of the lower endurance MLC partition if the data is likely to be deleted or made obsolete. If the received data satisfies neither the criteria for a heightened read probability nor the criteria for a heightened delete probability, the received data is transferred to the MLC partition in a background operation (at 408, 406).

Alternatively, if the binary partition 106 is so full that the minimum amount of space in the binary partition 106 is not available after receiving the data from the host, enough data is transferred to the MLC partition 108 until the minimum space becomes available (at 404, 406). In one embodiment, the received data is simply transferred to the MLC partition 108 when the available space in the binary partition 106 is less than the desired threshold. Alternatively, the processor 112 of the storage device 102 may first calculate the probability of reading or deletion of the received data and compare it to that of the probabilities of data already in the binary partition 106, such that the data with the greater read or delete probability is retained in the binary partition 106 while the data with the lesser read or delete probability is transferred to the MLC partition 108. In some instances, when the host 100 is keeping the storage device 102 too busy, a temporary bypass process may be implemented where the controller routes data received from the host directly to the MLC partition without first storing it in the binary partition. This bypass process may last as long as is necessary for sufficient space to become available again in the binary partition.

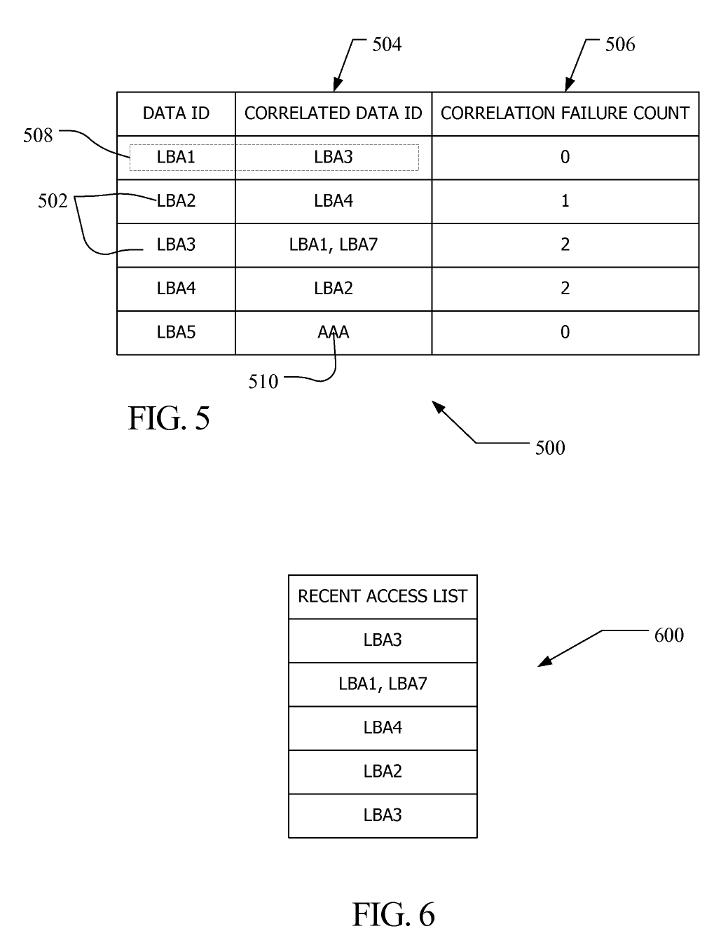

In one embodiment, read performance for the storage device 102 may be improved by the controller of the storage device monitoring characteristics of the read and/or write history of the data. These characteristics of the read and/or write history may be quantified as the criteria that need to be satisfied to indicate a heightened probability of particular data being read in the near operating future of the storage device. For example, as illustrated in FIG. 5, the storage device 102 may maintain a dynamic correlation table 500 to correlate different read groups of LBA runs that have recently been read in relatively close succession of each other. In the dynamic correlation table 500, each LBA (logical block address) address or address range that is requested in a recent read command from the host is identified by a data identifier (ID) 502 representative of an individual logical block address, or a run of logical block addresses. The second column of the dynamic correlation table data structure 500 includes a data correlation 504 listing of one or more data IDs of LBA addresses or ranges that were read in close succession after the data represented by the data ID in the first column. Thus, in the example of FIG. 5, LBA1 was read and subsequently LBA3 was read, so the LBA3 data ID is listed in the correlated data ID column of the data structure and is considered as being in the same read group 508 as data ID LBA1. The dynamic correlation table may also include a separate boot marker 510 in the correlated data ID entry 504 for a particular data ID 502 that identifies that data ID as having been read during a system boot. The controller may be configured to automatically record a boot marker 510 in the table 500 during the boot process of the storage device. Because the definition of a read group is based on dynamic observation of read patterns by the storage device and the storage device may not know whether the different data ID's in a read group are truly related, the read group may change as a result of later observed read activity following the data ID.

To accommodate for the dynamic nature of the correlations between LBA runs that may form read groups, for each subsequent read operation of a data ID that is not followed by a read of the previously correlated data ID (or correlated IDs) a correlation failure counter 506 is incremented and maintained in a correlation failure column of the table 500. When a series of correlation failures occur, the correlated ID entry associated with a particular data ID may be altered to remove the data ID of LBA runs in the correlated data ID entry 504 that no longer appear to be correlated with the data ID in the data ID entry. In one embodiment, the threshold number of correlation failures may be three before a data ID in the correlated data ID entry is removed from the table 500, although any fixed number of correlation failures may be used to determine when to change the data correlation entry to remove a data ID from a read group. The correlated data ID entry may also be expanded to include additional or new correlations observed when a new data ID is observed as being read with or soon after data represented by another data ID is read. In one implementation, the latest correlation between data IDs is promoted to the top of the data structure and the dynamic read correlation table 500 may be limited to having a finite length so that the data structure does not grow indefinitely.

In parallel with the dynamic correlation table 500 listing read groups 508 by correlated runs, a separate data structure may be maintained showing the most recently read data by data ID of the LBA run read from the device. This data structure may be in the form of a simple list 600 of finite length having at the top the data ID of the most recently read LBA run. As a new LBA run is accessed, it is placed at the top of the list and the oldest entry in the recent access list is bumped off the list. The finite lengths for the data structure 500 showing correlation between LBA runs that have been read (“the read group”) and of the recent accessed list 600 may be set based on expected usage of the host 100 and storage device 102. For example the lists could each be limited to 32 entries. Additionally, the data structures for the dynamic correlation table and the recent accessed lists 500, 600 may be kept in RAM 118 in the controller 110 or in the binary partition 106 of the non-volatile memory, or both.

The recent data read access information, such as shown in FIGS. 5 and 6, is one of a number of types of data read activity information that may be quantified and used as criteria for determining whether particular data has a heightened probability of being read in the near operating future of the storage device as compared to other data in the storage device. Other information that may be considered in making the determination includes: whether the data has previously been read during a system boot and may therefore be read during a subsequent system boot, whether the data was originally written immediately following data that was recently read, or by the order that the data in the binary partition was received.

The order of receipt, which represents the age, of host data into the binary partition 106 may be used to determine when to move data from the binary partition 106 to the MLC partition 108. For example, if the binary partition is configured as a simple first in first out (FIFO) arrangement, data that is the oldest may be selected to be moved to the MLC partition after a certain amount of time. Alternatively, if the storage device is configured with a storage address re-mapping data management arrangement, a separate table such as a block information table (BIT) may be used to determine the age of data by one or both of the order a block was written to and the order of data within a particular block of data.

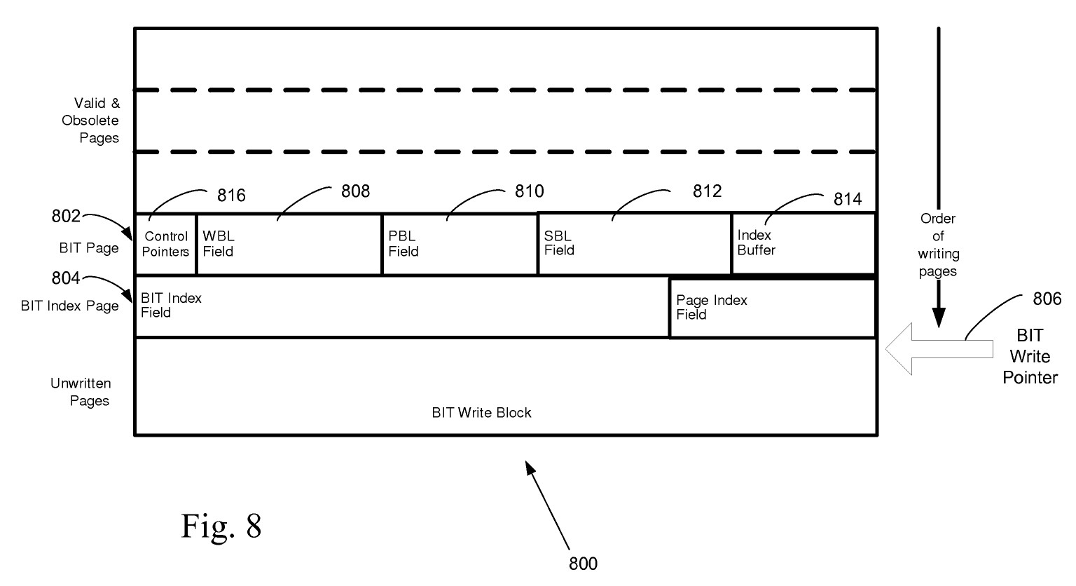

An example of a BIT write block 800 in a BIT is shown in FIG. 8. The BIT records separate lists of block addresses for white blocks, pink blocks, and storage address table (SAT) blocks. A BIT block may be dedicated to storage of only BIT information. It may contain BIT pages 802 and BIT index pages 804. BIT information is written in the BIT write block 800 at sequential locations defined by an incremental BIT write pointer 806. A BIT page location is addressed by its sequential number within its BIT block. An updated BIT page is written at the location defined by the BIT write pointer 806. A BIT page 802 contains lists of white blocks, pink blocks and SAT blocks with addresses within a defined range. A BIT page 802 comprises a white block list (WBL) field 808, a pink block list (PBL) field 810, a SAT block list (SBL) field 812 and an index buffer field 814, plus two control pointers 816.

The WBL field 808 within a BIT page 802 contains entries for blocks in the white block list, within the range of addresses relating to the BIT page 802. The range of addresses spanned by a BIT page 802 does not overlap the range of addresses spanned by any other BIT page 802. Within the WBL field, a WBL entry exists for every white block within the range of addresses indexed by the BIT page 802. Similarly, the SBL field 812 within a BIT page 802 contains entries for SAT blocks. The PBL field 810 contains entries for both pink and red blocks as well as a block counter that is recorded in the PBL field 810 for each pink or red block. The block counter is a sequential counter that indicates the order in which that particular block was written to. The counter in the PBL field 810 may be, for example, a two byte counter that can be used to count up to 64,000 blocks.

The storage address table (SAT) is used to track the mapping between the logical address assigned by the host and a second logical address assigned by the controller during re-mapping in the storage address re-mapping data management technique noted above. The SAT is preferably maintained in the binary partition in separate blocks from blocks containing data from the host. The SAT maps every run of addresses in logical address space that is allocated to valid data by the host file system to one or more runs of addresses in the address space of the storage device. More details on one version of a SAT and a BIT that may be adapted for use in the presently disclosed process and system may be found in U.S. application Ser. No. 12/036,014 already incorporated by reference above.

A determination that data has a heightened read probability is made by the processor regarding received data. The receipt of data may also increase the read probability of different data already in the MLC or binary partitions, for example through the correlation of received data to other data runs recorded in the data correlation table 500. When data is received at the binary partition of the storage device from the host, one or any combination of the above-mentioned criteria may be applied. If the received data meets any of the criteria, it may be retained in the binary partition as having a heightened probability of being read in the near future. Alternatively, the decision to retain information as having a high probability of being read may be based on a score that a group of data receives, where the score may simply be a point applied to each of the criteria that is satisfied or may be a score that is generated based on a weighting of points allocated to each of the criteria to which the incoming data satisfies. In embodiments where a score is used based on the data read probability criteria, a threshold may be set for the score where incoming data receiving a score at or greater than the threshold amount will be retained in binary 106 and that data not reaching the threshold score will be moved to the MLC partition 108.

Unlike the probability of data read criteria, which relates mainly to dynamic access history and the relation of LBA runs into read groups 508 as maintained in tables such as shown in FIGS. 5 and 6, the incoming data received at the binary partition may also be retained in the binary partition if it meets criteria for a high probability of near term deletion. This determination of the delete probability may be made by the controller 110 of the storage device 102 by examining data type information relating to the data being received. Knowledge of certain data types associated with received data may be used by the controller 110 to assess the probability of data deletion.

Categories of data type information that may be passed to the storage device 102 from a host 100 may include premium data, which is data designated by a particular marker or command provided by the host as data that the host wishes the storage device 102 to treat with extra care. The extra care may simply be to leave the data designated by the host as premium data in a more reliable or durable portion of memory memory, such as the binary partition 106. Examples of types of data a host 100 may designate as premium data may include data relating to tables of metadata for the file system, boot sectors, the file allocation table (FAT), directories or other types of data that is important to the functioning of the storage device 102 and could cause significant system problems if lost or corrupted.

Other data type information that the storage device 102 may consider in assessing the probability of deletion for a particular group of data may include temporary file data, master file table data (MFT), file extension information, and file size. The storage device controller 110 may maintain a table of these data types identifying which data types are considered to be, generally, likely to be related to data that has a greater probability of deletion in the near term. In such an embodiment, incoming data runs that have a data type falling within any one of the predetermined data types will be considered to have a high probability of deletion should any of the criteria for any of the data types be met. As with the schemes discussed for determining that criteria have been satisfied indicative of a probability of near term read, a weighting or ranking of the data type information may be maintained in the controller 110 such that certain of the data, for example premium data designated expressly by the host 100 for keeping in the binary partition 106, will not be moved from the binary partition 106 while other data types, regardless of the fact that they are somewhat more likely to be deleted in their near term may be ranked at a different level so that binary partition fullness will allow that particular type of data type to be moved to MLC 108 on an as needed basis.

The data type information may be received from the host 100 through initial data sent prior to a write burst from the host to the storage device 102. An example of one scheme for providing data tagging information, which may be data type information or file type information identifying specific files of a particular data type, is illustrated in U.S. application Ser. No. 12/030,018 filed Feb. 12, 2008 and entitled “Method and Apparatus for Providing Data Type and Host File Information to a Mass Storage System.” The entirety of the aforementioned application is incorporated by reference herein.

A storage device 102 working with a host 100 capable of providing such data tagging information may first receive a data tag command containing the information about the type of data to follow after the command. The tagging command may be received at the beginning of a burst of consecutively written data from the host. The burst of data may span one or more ATA write commands, which need not have continuous logical block addresses. In one embodiment, the storage device may interpret all data following a data tag command as being of the same data type until a new data type tag command is received from the host. The data type information received in the data tagging command would be compared by the storage device to a table of data type information considered to represent data that has a heightened probability of being deleted or made obsolete. For instance criteria indicative of a heightened probability of deletion may simply be a list or table maintained in non-volatile storage where the criteria is satisfied if the data tagging information preceding the burst of data from the host includes information that the burst of data is all relating to data having particular extension such as a .tmp (temporary file) extension.

Alternatively, the data specific information that the storage device 102 may use to determine whether received data has a heightened probability of being deleted (whether through data tagging information from the host or otherwise) may include file length information where file size less than a predetermined size may be recorded in the table as, on its own, indicative of a higher likelihood of deletion. Examples of such data with smaller file size include Internet browser cookies, recently written WORD files or short files that have been created by the operating system. Data in these shorter files is more likely to be deleted or made obsolete. In contrast, criteria weighing against a heightened likelihood of deletion may include data have a size or length greater than a given threshold. Examples of such larger files with an attendant lower probability of deletion in the near operating future of the device include executable files for applications, music (e.g. MP3) files and digital photograph files. The data specific information considered by the storage device in making the probability of deletion decision may be used alone by the storage device so that the determination is solely based on static information regarding the data type, or may be based on a combination of static information regarding the data and dynamic information such as whether a write or a read, or both a write and a read have recently been made to an LBA range that includes the received data.

Although a storage device 102 has been described as configured to maintain or move data into a binary partition 106 or into a MLC partition 108 based on determinations of a heightened probability of a read or a deletion of the data, it is contemplated that the storage device 102 may be configured to make only one type of determination (read or delete) without including the ability to make the other type of determination. The determination to keep data in, or move data to, the binary partition 106 that meets the criteria for heightened read or deletion probability may be made in a background process on the storage device while the device is idle. Idle is defined herein as when no host commands are pending at the storage device 102. The trigger for reviewing whether data is in an appropriate one of the partitions may be the receipt of new data at the device, or it may simply be an automatic process that cycles through all data in a partition during device idle times to compare the data runs to the current criteria maintained in the controller of the storage device

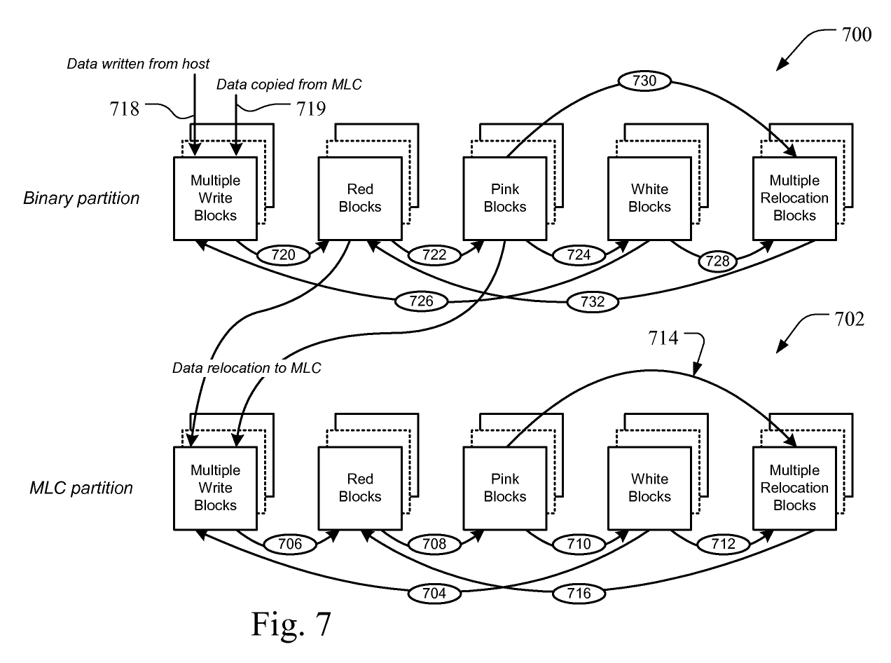

In order to manage data of different data types, in one embodiment the storage device 102 may group data identified by different data type tags, or by other information determined or received relating to data type of data in the storage device 102, into respective write blocks to which only data of a particular data type is directed. Referring again to the storage address remapping technique described in U.S. application Ser. No. 12/036,014 incorporated by reference above, the data tag information may be used by the storage device to group runs of data in the storage device according to the data type rather than its logical block address. The data may be moved between the binary 106 and MLC 108 partitions in terms of blocks of that same data type. Referring to FIG. 7, one example of a block state transition chart between the binary 700 and MLC partition 702 when using the storage address remapping technique is illustrated. The storage address re-mapping techniques may be executed by the controller 110 based on an instruction set maintained in a database 114 in the controller 110.

The block state transitions in the storage address re-mapping technique allocate address space in terms of blocks of clusters and fills up a block of clusters before allocating another block of clusters. In the MLC partition 702 this may be accomplished by first allocating a white block (a block containing no valid data which may be recycled for use as, for example, a new write block) to be the current write block to which data from the host is written, wherein the data from the binary partition 700 is written to the write block in sequential order according to the time it is received (at step 704). Separate write blocks for each data type may be maintained so that complete blocks of each data type may be easily moved. When the last page in the current write block for a particular data type is filled with valid data, the current write block becomes a red block (a block completely filled with valid data (at step 706) and a new write block is allocated from the white block list. It should be noted that the current write block may also make a direct transition to a pink block (i.e., a block containing both valid and invalid pages of data) if some pages within the current write block have already become obsolete before the current write block is fully programmed.

Referring again to the specific example of block state transitions in FIG. 7, when one or more pages within a red block are made obsolete by deletion of an LBA run, the red block becomes a pink block (at 708). When the storage address re-mapping algorithm detects a need for more white blocks, the algorithm initiates a flush operation to move the valid data from a pink block so that the pink block becomes a white block (at 700). In order to flush a pink block, the valid data of a pink block is sequentially relocated to a white block that has been designated as a relocation block (at 712 and 714). Once the relocation block is filled, it becomes a red block (at 716). As noted above with reference to the write block, a relocation block may also make the direct transition to a pink block if some pages within it have already become obsolete.

The block state changes (at steps 718-732) in the binary partition 700 differ from those of the MLC partition 702. In the binary partition 700 data of a particular data type is received from the host or from the MLC partition 700 (at 718, 719) at a write block for that particular data type. The write block is sequentially written to until it is filled and becomes a red block (at 720). If pages for a red block become obsolete, the block becomes a pink block (at 722). Pink blocks may be flushed as discussed above with respect to the MLC partition 702 to create new white blocks (at 704) which are then assigned as new write blocks (at 726) in the binary partition. White blocks may be assigned as relocation blocks (at 728) that, when filled with valid data flushed from pink blocks (at 730), become red blocks (at 732).

However, if one or more of the processes to improve write performance, read performance and memory life discussed above are applied to data received at the binary partition, data from the binary partition may be sent to the MLC partition. For example if the data received in the binary partition 700 fails to satisfy the heightened read probability criteria, the data may be sent to the MLC partition. In an implementation using the storage address re-mapping techniques of FIG. 7, that received data may be in the form of valid data from the pink blocks in the binary partition 700 or valid data from red blocks in the binary partition. The transferred data from the binary partition may be transferred to corresponding write blocks in the MLC partition reserved for data having the appropriate data type or other characteristic to which the write block is assigned. Referring to the BIT write block 800 of FIG. 8, a storage device configured to move blocks, or relocate data from one block to another in or between partitions, based on data type may use the BIT table to record the data type for each block. Each BIT page 802, in the PBL field 810, may include data type information for the particular pink or red block and thus the controller may store this information in the BIT and manage blocks and data based on data type.

A method and system have been disclosed for relocating selected data within a non-volatile memory having storage portions with different performance characteristics, such as different endurance ratings. The determination of read probability only, determination of only the probability of data becoming obsolete or deleted, or the combination of both techniques may be used to decide whether to retain data determined to satisfy criteria applied by the storage device that indicates a heightened probability of one or both situations may be implemented. While the probability of a data read may be only based on read history criteria for LBA runs, it may also include static information regarding the data, such as data type. Further, the data read probability determination may further include historical information relating to prior write or deletion activity relating to data in the storage device. In contrast, the determination of heightened probability of data becoming obsolete or deleted may rely on one or more static pieces of information regarding a group of data, such as file size and data type information.

Other storage device activity, including write or read activity may be factored in as well. In one embodiment, recently written data may have its probability of being read or deleted increased over other data meeting one or more of the described criteria, but that was not also recently written to the binary partition. The recently written data may have its probability increase by multiplying any probability score that the controller may have determined by a multiplier, for example by 1.5. The time definition of “recently written” may be set in any number of ways, for example by a simple block count that tracks a set number of the most recent number of blocks that have been written and any data written to the those blocks (e.g. the last written 10 blocks) may be considered recently written. Information as to the order of when a block was written to may be obtained, in implementations using storage address re-mapping data management as described above, by referencing the block information table (BIT) in which the controller records time stamp data for each block in non-volatile memory.

In either analysis, whether done singly or in combination, a determination that the data received from a host meets the heightened probability criteria will allow the storage device to maintain the data in binary where read performance may be faster and memory endurance greater than in the MLC partition. Although there may be some processing overhead cost in a storage device that moves data between the different storage portions, the overall performance of a storage device may be improved by properly allocating data to the appropriate partitions portions based on the predicted read or deletion probabilities.

It is therefore intended that the foregoing detailed description be regarded as illustrative rather than limiting, and that it be understood that it is the following claims, including all equivalents, that are intended to define the spirit and scope of this invention.

We claim:

1. A method of relocating selected data between partitions in a non-volatile storage device, the method comprising:
receiving data in a first type of non-volatile memory in the non-volatile storage device;
determining in the non-volatile storage device if the received data satisfies heightened read probability criteria, wherein the heightened read probability criteria identify received data having a greater probability of being read from the non-volatile storage device in a near term than an average read probability of data in the non-volatile storage device; and
transferring the received data from the first type of non-volatile memory to a second type of non-volatile memory in the non-volatile storage device if the received data is determined not to satisfy the heightened read probability criteria, wherein the first type of non-volatile memory comprises a higher endurance memory than the second type of non-volatile memory.

2. The method of claim 1, wherein the first type of non-volatile memory comprises single level cell (SLC) flash memory.

3. The method of claim 2, wherein the second type of non-volatile memory comprises multi-level cell (MLC) flash memory.

4. The method of claim 3, wherein determining if the received data satisfies heightened read probability criteria comprises the storage device determining if the received data corresponds to data recently read from the storage device.

5. The method of claim 4, wherein determining if the received data corresponds to data recently read from the storage device comprises the storage device maintaining at least one table of logical block addresses of data recently read from the storage device and comparing a logical block address of the received data to logical block addresses in the at least one table.

6. The method of claim 1, further comprising determining in the non-volatile storage device if the received data satisfies a deletion probability criteria, wherein the deletion probability criteria identifies received data having a heightened probability of being deleted, and transferring the received data from the first type of non-volatile memory to the second type of non-volatile memory in the non-volatile storage device if the received data is determined not to satisfy the heightened deletion probability criteria.

7. The method of claim 3, further comprising maintaining a copy the received data in the SLC partition if the read probability criteria are met.

8. A method of relocating selected data between partitions in a non-volatile storage device, the method comprising:
receiving data in a first type of non-volatile memory in the non-volatile storage device;
determining in the non-volatile storage device if the received data satisfies a deletion probability criteria, wherein the deletion probability criteria identifies received data having a heightened probability of being deleted
transferring the received data from the first type of non-volatile memory to a second type of non-volatile memory in the non-volatile storage device only if the received data fails to meet the deletion probability criteria, wherein the first type of non-volatile memory comprises a higher endurance memory than the second type of non-volatile memory.

9. The method of claim 8, wherein the first type of non-volatile memory comprises single level cell (SLC) flash memory.

10. The method of claim 9, wherein the second type of non-volatile memory comprises multi-level cell (MLC) flash memory.

11. The method of claim 10, wherein the received data comprises data from a host file and information relating to the host file.

12. The method of claim 11, wherein the information relating to the host file comprises a file extension for the host file.

13. The method of claim 11, wherein the information relating to the host file comprises a file size of the host file.

14. A method of relocating selected data between partitions in a non-volatile storage device, the method comprising:
reviewing information regarding a group of data stored in a low endurance type of non-volatile memory in the non-volatile storage device;
determining in the non-volatile storage device if the information regarding the group of data stored in the low endurance type of non-volatile memory satisfies a heightened read probability criteria, wherein the read probability criteria identifies the group of data having a heightened probability of being read in a near operating future of the non-volatile storage device; and
generating a second copy of the group of data in a high endurance type of non-volatile memory in the non-volatile memory device if the group of data satisfies the read probability criteria wherein a first copy is retained in the low endurance type of non-volatile memory and the second copy is simultaneously maintained in the high endurance type of non-volatile memory.

15. The method of claim 14, wherein the high endurance type of non-volatile memory comprises single level cell (SLC) flash memory.

16. The method of claim 15, wherein the low endurance type of non-volatile memory comprises multi-level cell (MLC) flash memory.

17. The method of claim 16, wherein determining if the received data satisfies heightened read probability criteria comprises the storage device determining if the received data corresponds to data recently read from the storage device.

18. A non-volatile storage device for relocating selected data between partitions in the non-volatile storage device, comprising:
a first type of non-volatile memory;
a second type of non-volatile memory, the second type of non-volatile memory having a lower endurance than that of the first type of non-volatile memory; and
a controller configured to:
determine if data received at the first type of non-volatile memory satisfies heightened read probability criteria, wherein the heightened read probability criteria identify data having a greater probability of being read from the non-volatile storage device in a near term than an average read probability of data in the non-volatile storage device; and
transfer the received data from the first type of non-volatile memory to a second type of non-volatile memory in the non-volatile storage device if the received data is determined not to satisfy the heightened read probability criteria.

19. The storage device of claim 18, wherein the first type of non-volatile memory comprises single level cell (SLC) flash memory and the second type of non-volatile memory comprises multi-level cell (MLC) flash memory.

20. The storage device of claim 19, further comprising at least one table of logical block addresses of data recently read from the storage device and wherein the controller is further configured to:
compare a logical block address of the received data to logical block addresses in the at least one table, and
determine that the received data satisfies heightened read probability criteria if the received data corresponds to data recently read from the storage device.
